(19) United States
(12) Patent Application Publication
(10) Pub. No.: US 2004/0003121 A1
(43) Pub. Date: Jan. 1, 2004

(54) Document server and recording medium recording document processing program

(75) Inventor: Yoshifumi Tanimoto, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: MURATA KIKAI KABUSHIKI KAISHA, Kyoto-shi (JP)

(21) Appl. No.: 10/409,142

(22) Filed: Apr. 9, 2003

(30) Foreign Application Priority Data
Apr. 12, 2002 (JP) 2002-111215

(51) Int. Cl. G06F 15/16

(52) U.S. Cl. 709/246

(57) ABSTRACT

To provide a document server which can use a document without preparing various application programs regardless of a data format of the document. In response to a request from a client, a converted document data generation unit retrieves a document from a document storage unit, generates a converted document data of HTML format or the like, and transmits the generated converted document data to the client through a network communication unit. When the client inputs information into an input item and the converted document data is returned to the document server, a document embedding unit extracts the input information and embeds the extracted input information into the input item of the original document to form a new document. According to a request, a preview image data generation unit generates preview image data from the new document, and transmits to the client. The preview image data is displayed at the client, and the preview is realized. The new document embedded with the input item can be transmitted in form of a facsimile or an electronic mail to a destination indicated by the client.

### FIELD OF THE INVENTION

The present invention relates to a system which can edit a document and transmit the edited document.

### DESCRIPTION OF THE RELATED ART

Accompanying a recent development in a network, various documents are being stored in a document server, and the stored documents are being used by a client. For example, form data common for a plurality of clients can be stored in the document server, and a client can retrieve the form data from the document server. Then, the client can enter a prescribed item, and a new document can be formed.

However, there are various application programs for forming a document. Therefore, when the documents that are formed by various application programs are registered in the document server, a client which references these documents must have the application programs used when each of the documents was formed.

In a conventional system, for allowing a document to be used by all clients, the document to be stored in the document server can be described in a specific data format such as a Hyper Text Markup Language (HTML). In such a system, there is an advantage in that the client is not required to have all of the various application programs. However, since the data format of the document stored in the document server is limited to a specific data format such as HTML, the document cannot be formed unless the client is familiar with the specific data format such as HTML. Alternatively, there exists a problem that the document to be registered to the document server cannot be formed or edited by using various document editing application programs.

### SUMMARY OF THE INVENTION

The present invention was made in consideration of the above-described problems. An advantage of the present invention is to provide a document server and a recording medium recording a document processing program, wherein a client can use a document without preparing various application programs even if the document is formed under a data format other than a specific data format, and the document server and the document processing program can be used in a system which can transmit the edited document to another device.

The document server of the present invention includes a generation unit, a communication unit, and an embedding unit. The generation unit generates converted document data converted into a prescribed data format from a document including an input item described in accordance with a prescribed rule. The communication unit transmits the converted document data to a client, and receives the converted document data including an input information input to the input item. The embedding unit embeds the input information into the input item in the document in accordance with the received converted document data.

As described above, since the converted document data of the prescribed data format is generated from the document by the generation unit, if the client has the application program which can reference or edit the document by the prescribed data format, the client can reference or edit any one of the documents in the document server. In this case, by describing the input item in the document under a prescribed rule, the input item is also reflected to the converted document data, and the client can complete the document just by inputting to the input item. Furthermore, the information input by the client is embedded into the original document, and a new document is generated.

Therefore, even when the application program used for generating the document and the application program used by the client are different, the document can be edited.

Furthermore, the document server of the present invention can include a transmission unit which transmits the document embedded with the information input by the client as described above. In this case, destination information can be included in the converted document data having the input information for the received input item, and the document can be transmitted in accordance with the destination information at the time of transmission. The document can be transmitted as electronic mail, a facsimile, or the like.

In this case, when transmitting as electronic mail, the document to be transmitted is converted into transmission data of an electronic mail format, and then transmitted. Moreover, when transmitting as a facsimile, the document to be transmitted is converted into facsimile transmission data (for example, bitmap image or the like), and is then transmitted.

Furthermore, the document server of the present invention includes a preview image data generation unit which generates preview image data of a prescribed data format from the document embedded with the input information. The document server can transmit the preview image data generated by the preview image data generation unit to the client, and realize the preview. Accordingly, it can be confirmed what kind of document has been generated in accordance with the information input by the client. For example, when transmitting the document generated as described above, the document can be checked before being transmitted.

According to the present invention, the document which has been formed by various application programs can be used by a client which does not support such application programs, and the editing of the document becomes possible. Moreover, since the information input by the client is embedded into the original document, the edit result is the same as when the original document is edited. Furthermore, the result of embedding the input information into the original document can be confirmed by previewing, or the result can be transmitted as electronic mail or a facsimile directly.

### BRIEF DESCRIPTION OF THE DRAWINGS

FIG. 1 illustrates a system including a document server according to an embodiment of the present invention.

FIG. 2 illustrates an operation of the system including the document server according to an embodiment of the present invention.

FIG. 3 illustrates an example of a document stored in a document storage unit.

FIG. 4 illustrates an example of converted document data.

FIG. 5 illustrates an example of a display screen at a client.

FIG. 6 illustrates an example of a display screen after information is input at the client.

FIG. 7 illustrates an example of a document embedded with input information.

FIG. 8 illustrates another example of a document stored in the document storage unit.

FIGS. 9 and 10 illustrate another example of converted document data.

FIG. 11 illustrates another example of a display screen at a client.

FIG. 12 illustrates another example of a display screen after the information is input at a client.

FIG. 13 illustrates another example of a document embedded with input information.

### DETAILED DESCRIPTION OF THE PREFERRED EMBODIMENTS

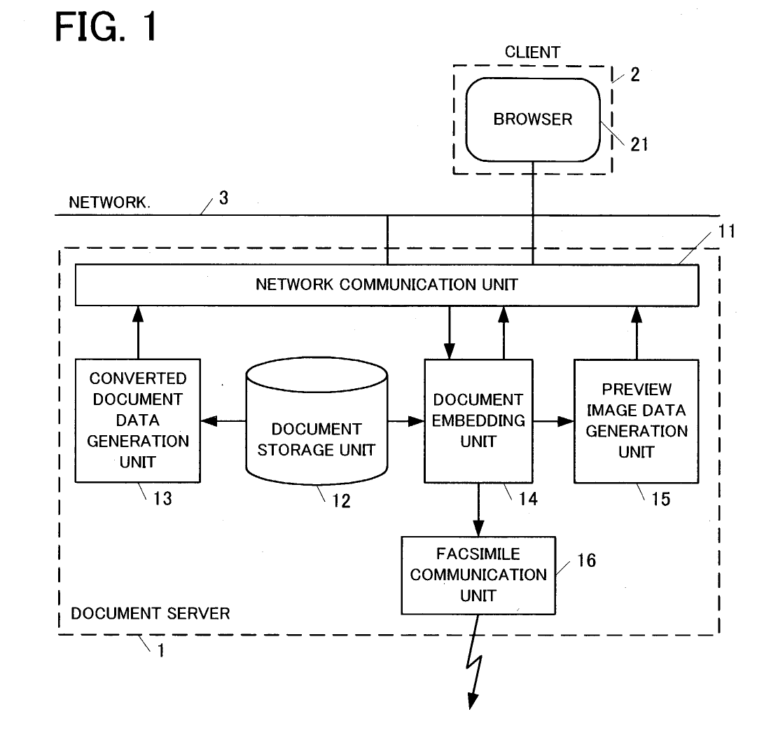

FIG. 1 illustrates a system including a document server according to an embodiment of the present invention. FIG. 1 shows a document server 1, a client 2, a network 3, a network communication unit 11, a document storage unit 12, a converted document data generation unit 13, a document embedding unit 14, a preview image data generation unit 15, a facsimile communication unit 16, and a browser 21.

In the system shown in FIG. 1, the document server 1 and the client 2 are connected to the network 3, and the document server 1 and the client 2 can communicate with each other. Moreover, other various network devices can be connected to the network 3. The network 3 can be a Local Area Network (LAN), the Internet, a public network, a private line or the like. Further, the client 2 can be any device which includes an application program that is capable of simple displaying and inputting data. For example, the client 2 can be a portable device, or a cellular phone. Moreover, the client 2 can also be a personal computer, a multifunction network device or the like.

The document server 1 stores various documents, and provides an original document according to a request from the client 2. At this time, the document server 1 generates the original document of a prescribed data format such as a Hyper Text Markup Language (HTML) or a Portable Document Format (PDF), and then provides the original document to the client 2 which requested the document. Moreover, data is input to the original document of the prescribed format provided to the client 2, and the document server 1 receives the original document. Then, the document server 1 embeds the input information into the original document, and generates a new document. The document server 1 includes a preview function for forwarding the generated new document as image data or the like to the client 2. In addition, the document server 1 includes a function for transmitting the new document in the form of an electronic mail, a facsimile, or the like.

In the example shown in FIG. 1, the document server 1 includes the network communication unit 11, the document storage unit 12, the converted document data generation unit 13, the document embedding unit 14, the preview image data generation unit 15, the facsimile communication unit 16 or the like.

The network communication unit 11 communicates through the network 3 with network devices including the client 2. For example, the network communication unit 11 can receive the document to be registered to the document storage unit 12, transmit the converted document data generated by the converted document data generation unit 13, receive the converted document data input with various information, and transmit the preview image data. In this example, the network communication unit 11 functions as a communication unit as described above, and also functions as a transmission unit which transmits the electronic mail including the document generated by the document embedding unit 14.

The document storage unit 12 stores various documents. Moreover, the document to be stored can be uploaded through the network 3. The data format of the document being stored can be any type of data format if the data format is processable by the converted document data generation unit 13. In the present invention, the application program used when forming the document is not necessary to be included in the client 2 which uses the document. Therefore, when forming the document, various applications can be used. Here, a form document which can be used for general purpose is being stored as an example of the document to be stored. In the document, an input item for a user to input as information such as a prescribed item can be described under a prescribed rule. Moreover, the document to be stored can be any document.

The converted document data generation unit 13 retrieves the document stored in the document storage unit 12 in accordance with a request from the client 2. Then, the converted document data generation unit 13 generates the converted document data of a prescribed data format such as HTML or PDF. At this time, when the input item is described in the document under a prescribed rule, the description is converted such that the client 2 can input into the input items. Moreover, even if various descriptions which become necessary in a later processing are not included in the original document, the various descriptions can be added. For example, the descriptions such as a return address or a button for indicating a reply for when returning the converted document data can be added to the original document. Further, the converted document data generated by the converted document data generation unit 13 is transmitted to the client 2 from the network communication unit 11.

The document embedding unit 14 receives the converted document data from the client 2 through the network communication unit 11. The information, which the user has inputted into the input item at the client 2, is included in the received converted document data. The document embedding unit 14 embeds the input information included in the received converted document data into the input item of the document which is the original of the converted document data, and generates a new document.

Further, when there is a request for a preview from the client 2, the generated new document is sent to the preview image data generation unit 15. Moreover, when the electronic mail transmission is designated, the new document is converted into transmission data of an electronic mail format, and is sent to the network communication unit 11. When the facsimile transmission is designated, the new document is converted into facsimile transmission data such as bitmap data, and is sent to the facsimile communication unit 16. Further, in the case of the electronic mail transmission or the facsimile transmission, destination information described in the converted document data received from the client 2 is obtained. The obtained destination information is handled as a destination of the transmission data. In the case of the electronic mail, the destination information is included in an address section. In the case of the facsimile, the destination information is notified to the facsimile communication unit 16 as a telephone number or the like of the destination.

The preview image data generation unit 15 generates preview image data of a prescribed data format such as bitmap data from the new document embedded with the input information by the document embedding unit 14. The preview image data is not limited to the bitmap, and can be data of any data format if the data format can be referenced by the client 2. Moreover, the preview image data can be compressed by a compression method such as a Joint Photographic Experts Group (JPEG). The preview image data is transmitted to the client 2 through the network communication unit 11, displayed at the client 2, and the preview is realized.

The facsimile communication unit 16 receives the transmission data and the information of the destination from the document embedding unit 14. Then, the facsimile communication unit 16 transmits the transmission data by facsimile to the destination through a public network, a private line or the like.

Further, in the above-described example, the new document embedded with the input information is transmitted in form of electronic mail and as a facsimile. Of course, only either electronic mail or facsimile can be adopted. For example, when the facsimile transmission is not carried out, the facsimile communication unit 16 becomes unnecessary. Alternatively, when an electronic mail transmission is carried out, the facsimile communication unit 16 can be used, and by connecting to an Internet Service Provider (ISP) through a public network, a private line or the like, the electronic mail can be transmitted.

Moreover, when the preview function is not used, the preview image data generation unit 15 becomes unnecessary. Alternatively, the converted document generation unit 13 can serve as the preview image data generation unit 15.

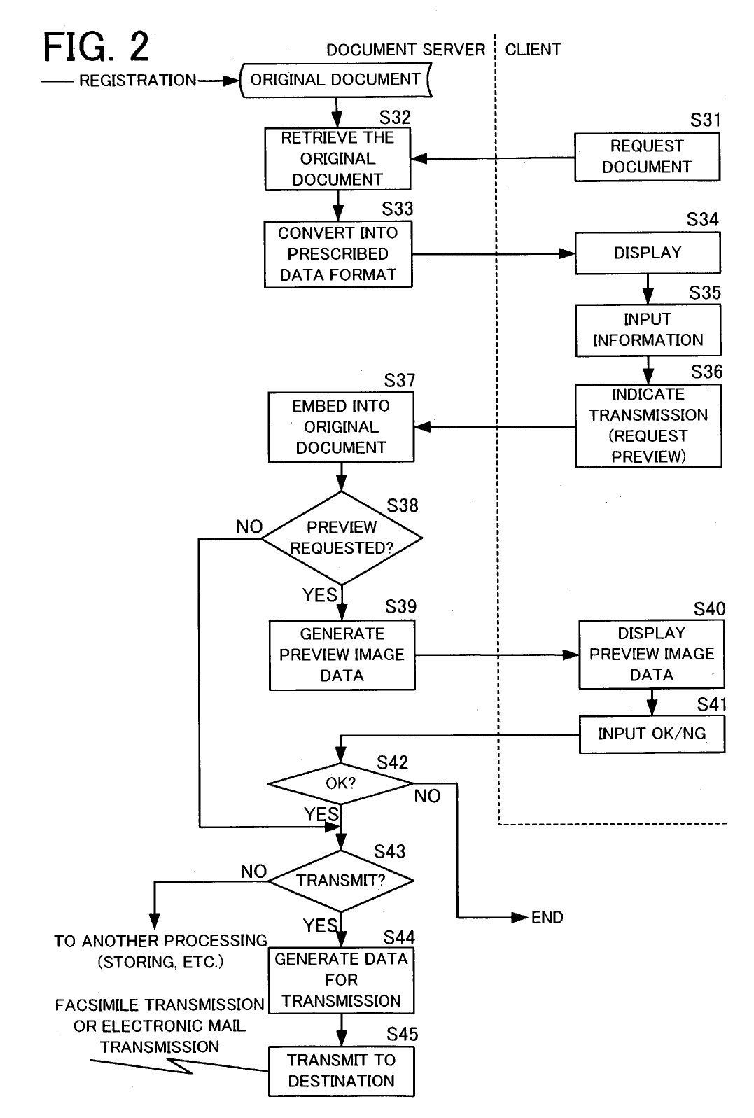

FIG. 2 illustrates an example of an operation of a system including the document server according to an embodiment of the present invention. A document is registered in advance in the document storage unit 12 of the document server 1. The registered document can be a document of various data formats if the data format can generate the converted document data at the converted document generation unit 13 as described above.

When the client 2 wishes to use the document stored in the document server 1 (hereinafter referred to as an original document), the client 2 requests the original document to the document server 1 in S31. In S32, the document server 1 retrieves the requested original document from the document storage unit 12 in accordance with a request of the document from the client 2. In S33, the converted document data generation unit 13 generates the converted document data of a prescribed data format from the original document retrieved from the document storage unit 12. Then, the generated converted document data is transmitted to the client 2.

In S34, the converted document data transmitted from the document server 1 is displayed, and the content of the document can be referenced at the client 2. For example, if the converted document data of the HTML format is generated in S33, the client 2 can reference the document by a simple browser 21 or the like.

Therefore, even when the document stored in the document server 1 is a document of any data format, if the client 2 has the browser 21, the document can be referenced. In this case, since the converted document data is independent of the application program, the converted document data is also independent of an Operating System (OS) or the like in the client 2, and the document in the document server 1 can be used in a different operation environment.

When the original document requested from the client 2 is form data or the like, several input items are included in the document. The input items are described under a prescribed rule. The converted document data is generated such that the client 2 can input to the input items when generating the converted document data by the converted document data generation unit 13.

Therefore, when the converted document data is displayed at the client 2 in S34, it becomes possible to input the information into each of the input items. Further, when inputting the information into the input items, in the case of transmitting the document input with the information, the destination information is also input into the input items. Moreover, when requesting a preview, the input item for requesting the preview can be input (for example, checking the input item).

In S35, the information is input into the input item of the displayed converted document data at the client 2. Then, in S36, the transmission of the converted document data is indicated to the document server 1. A “transmit” button can be displayed when the converted document data is displayed, and the indication can be made by operating the “transmit” button.

When the document server 1 receives the converted document data input with the information in the input item from the client 2, the document server 1 sends the converted document data to the document embedding unit 14. In S37, the document embedding unit 14 extracts the input information input in the input item of the converted document data, embeds the extracted input information into the input item in the original document, and generates a new document.

Then, in S38, it is determined whether or not there is a request for preview. When there is a request for preview, in S39, the new document which the input information has been embedded by the document embedding unit 14, is sent to the preview image data generation unit 15. Then, the preview image data generation unit 15 generates preview image data, and the generated preview image data is transmitted to the client 2.

In S40, the received preview image data is displayed at the client 2 by using the browser 21 or the like, and the preview can be carried out. In S41, it is determined whether or not the preview image is OK or NG as a result of previewing the image, and the determination result is returned to the document server 1.

The document server 1 receives the indication of whether the preview image is OK or NG from the client 2. In S42, the document server 1 determines the indication. When receiving the indication of OK for the preview image, the process proceeds to S43. When receiving the indication of NG for the preview image, the new document formed by the document embedding unit 14 is deleted, and the processing is ended. Alternatively, the original document can be retrieved from the document storage unit 12, or the new document formed by the document embedding unit 14 can be used, and the processing after S33 can be repeated. Further, when transmitting the preview image to the client 2, the converted document data generated in S33 or the converted document data inserted with the input information can be transmitted to the client 2, and in the case where there is inconvenience in the preview image, a correction can be made immediately to the preview image.

When it is determined that there is no request for preview in S38, and when it is determined that an indication of OK for the preview image has been received in S42, in S43, it is determined whether or not to transmit the new document generated by the document embedding unit 14. This determination can be made by referencing the input item which shows whether or not to transmit, or by determining whether or not the destination information is input. When not transmitting, for example, if another processing is designated, the designated processing is carried out. For example, the document can be stored to the document storage unit 12, or the document can be printed by a printer (not shown in the drawings).

When it is determined that the transmission is indicated in S43, the new document generated by the document embedding unit 14 is converted into transmission data in S44. Then, in S45, the transmission data is transmitted to the destination. For example, when the electronic mail transmission is indicated, an electronic mail which includes the e-mail address included in the destination information is formed, and the electronic mail is transmitted from the network communication unit 11. Further, the electronic mail includes the new document generated by the document embedding unit 14 as a main text of the electronic mail or as an attached file. Moreover, when the facsimile transmission is indicated, the new document generated by the document embedding unit 14 is converted into facsimile image data and made as transmission data. In addition, the transmission data and the telephone number included in the destination information are sent to the facsimile communication unit 16. The facsimile communication unit 16 makes a call to the received telephone number, and transmits the transmission data by the facsimile.

As described above, even if the client 2 is not provided with the application which was used when each of the documents has been formed, the document can be referenced or edited by the simple browser 21 or the like, and the transmission can be indicated. Moreover, when there is a request, the image data to be transmitted can be previewed and confirmed.

Further, the communication between the document server 1 and the client 2 can be carried out by using various protocols used in a network, such as a Hyper Text Transfer Protocol (HTTP), a File Transfer Protocol (FTP), electronic mail using a Simple Mail Transfer Protocol (SMTP), a Post Office Protocol (POP), or the like. In the present invention, there is an advantage that a general purpose protocol can be used for the communication between the document server 1 and the client 2 as described above.

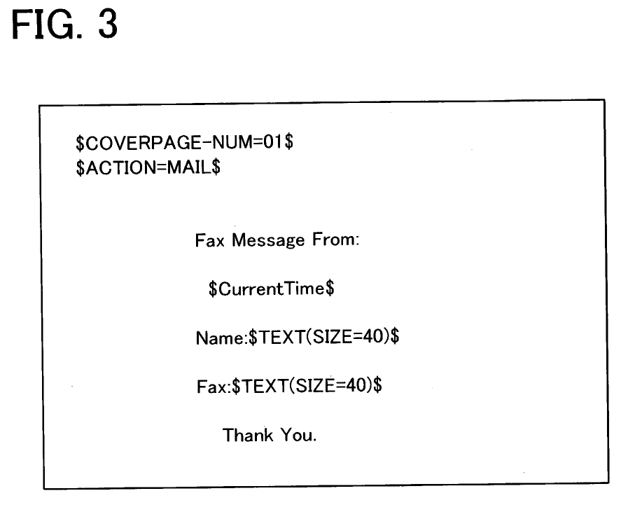

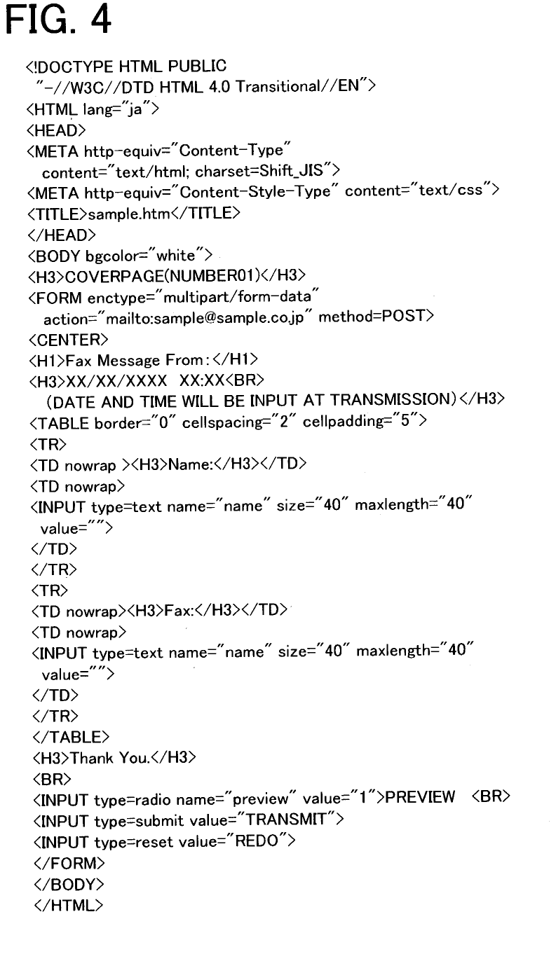

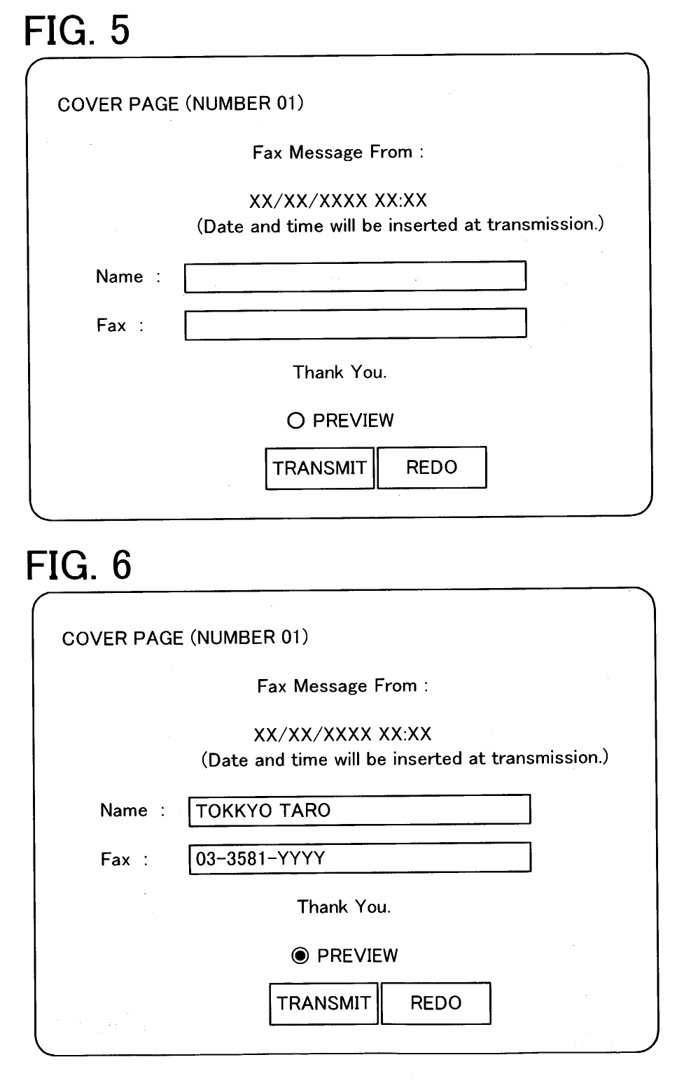

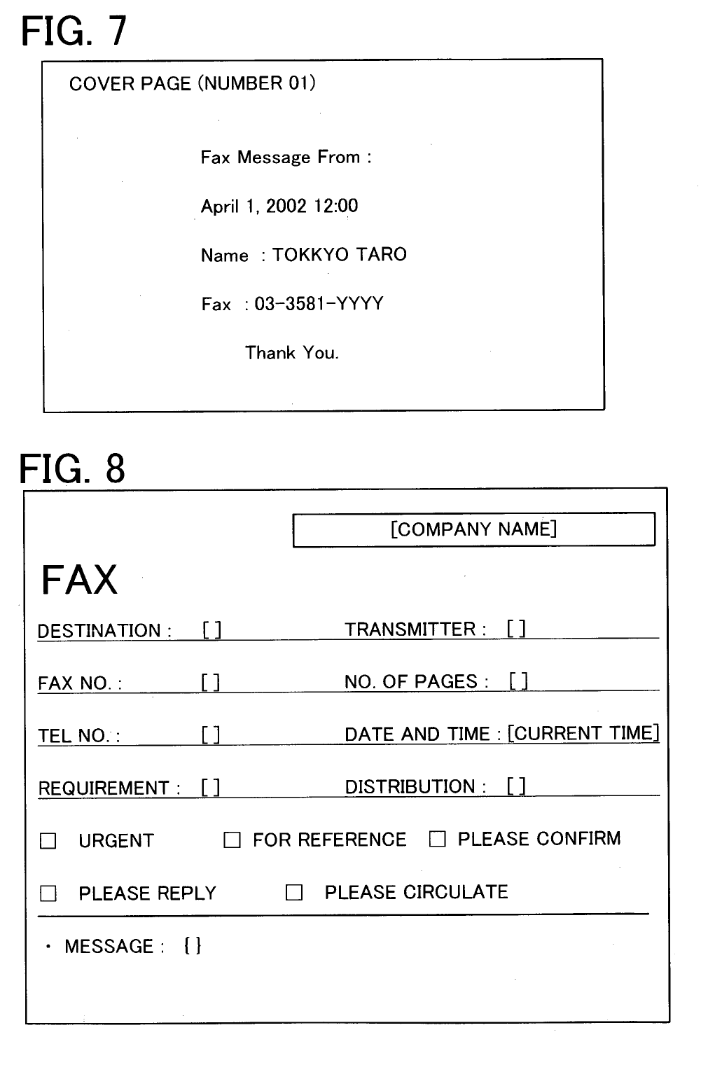

Next, an example of the above-described operation will be described with reference to a specific example. FIG. 3 illustrates an example of an original document stored in the document storage unit 12. FIG. 4 illustrates an example of a converted document data. FIG. 5 illustrates an example of a display screen at a client. FIG. 6 illustrates an example of a display screen after the information is input at a client. FIG. 7 illustrates an example of a document embedded with input information. FIG. 3 through FIG. 7 show examples in which the original document which generalizes a cover page of the facsimile transmission is stored in the document storage unit 12 and used.

The content can be described in the original document to be stored in the document storage unit 12, by using a prescribed notation as shown in FIG. 3 as an example. In this example, a part bracketed by ‘$’ is a part showing an indication to the document server 1. Specifically, “$COVERPAGE-NUM=01$” located at upper left shows that “01” will be inserted as the cover page number. Moreover, “$ACTION=MAIL$” in the next line indicates for the return mail received from the client 2 to be in the form of the electronic mail.

Since “Fax Message From:” located in the center part is not bracketed by ‘$’, a character string is reflected directly. “$CurrentTime$” indicates a present date and time. For example, a time of transmission, a time of when the transmission data is formed, or a time of when the new document embedded with the input information is formed is inserted in this part. “$TEXT(SIZE=40)$” in the next two lines indicates the input item to be input in form of a text. Here, it is indicated to form an input column of 40 digits. Such a document can be formed by any application program such as a word processing or a spreadsheet, and stored in the document storage unit 12.

When forming a cover page by using the original document shown in FIG. 3 from the client 2, the original document is specified by a file name or the like, and a request is made to retrieve the original document. Then, the document server 1 retrieves the designated original document from the document storage unit 12, and generates the converted document data of a prescribed data format by the converted document data generation unit 13. FIG. 4 shows an example in which the converted document data of the HTML format is generated from the original document shown in FIG. 3.

In, the example of the converted document data shown in FIG. 4, in accordance with the description in the document shown in FIG. 3, “COVER PAGE (NUMBER 01)” is generated from the description of “$COVERPAGE-NUM=01$”, and a format of the electronic mail, an address of the destination (“sample≃sample.co.jp”), or the like is generated from the description of “$ACTION=MAIL$” such that an electronic mail will be formed when transmitting a return mail.

Furthermore, a description is generated from the description of “$CurrentTime$” such that a character string indicating unspecified date and time such as “XX/XX/XXXX XX:XX” and a message such as “(DATE AND TIME WILL BE INSERTED AT TRANSMISSION)” are displayed. Furthermore, a description for providing the input column is generated from the two “$TEXT(SIZE=40)$” respectively.

In addition, although not included in the original document shown in FIG. 3, a description is generated to provide a “redo” button or a “transmit” button for making various indications at the client 2, and a radio button for indicating preview.

The converted document data as shown in FIG. 4 is transmitted to the client 2. A display as shown in FIG. 5 is shown by the browser 21 or the like at the client 2. The client 2 can input the name of the transmitter, a facsimile number or the like, and operate the “transmit” button. FIG. 6 shows an example of the display screen when the name (“TOKKYO TARO)” and the facsimile number (03-3581-YYYY) are input. By operating the “transmit” button under this status, the converted document data input with the above information is forwarded to the document server 1 as the electronic mail.

When the document server 1 receives the converted document data input with the information by the client 2 in the form of the electronic mail, the document embedding unit 14 in the document server 1 analyzes the content of the received converted document data, extracts the input information, and inserts the extracted input information into the original document (document shown in FIG. 3). Accordingly, the document as shown in FIG. 7 is generated newly.

In the example shown in FIG. 6, the radio button indicating the preview is selected. Therefore, the newly generated document shown in FIG. 7 is sent to the preview image data generation unit 15, preview image data is generated, and the preview image data is sent to the client 2 again. At this time, the HTML document for displaying the preview image data can be generated, and the HTML document including the preview image data can be transmitted to the client 2. The display at the client 2 can be that as shown in FIG. 7. The buttons for “OK” or “NG” can be also provided in the display.

In this embodiment, the generation of the cover page was described. The new document formed as described above can be stored in the document storage unit 12 or the like, and can be transmitted along with other documents.

Moreover, the input item for inputting the destination information or the input item for designating the document to be transmitted along with the cover page can be included. Even if these input items are not included in the original document, the destination information or the transmission information can be designated when generating the converted document data or when transmitting the preview image data. When the transmission is indicated under the above structure, a facsimile transmission can be carried out by the facsimile communication unit 16 by using a cover page formed as described above.

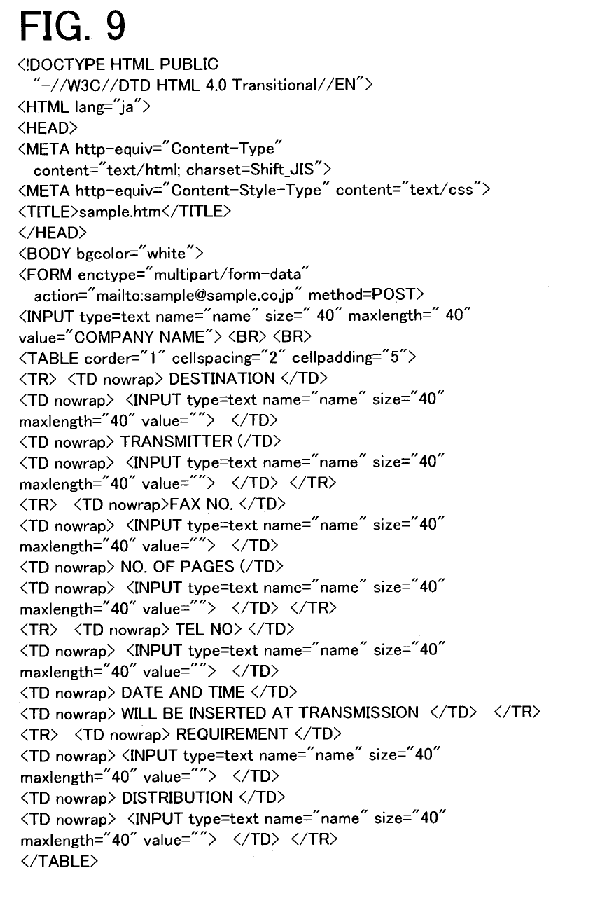

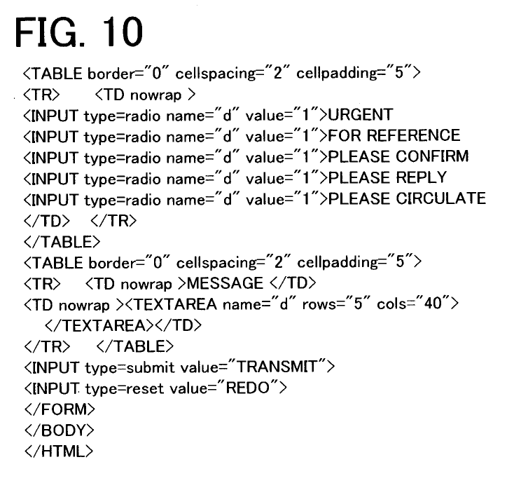

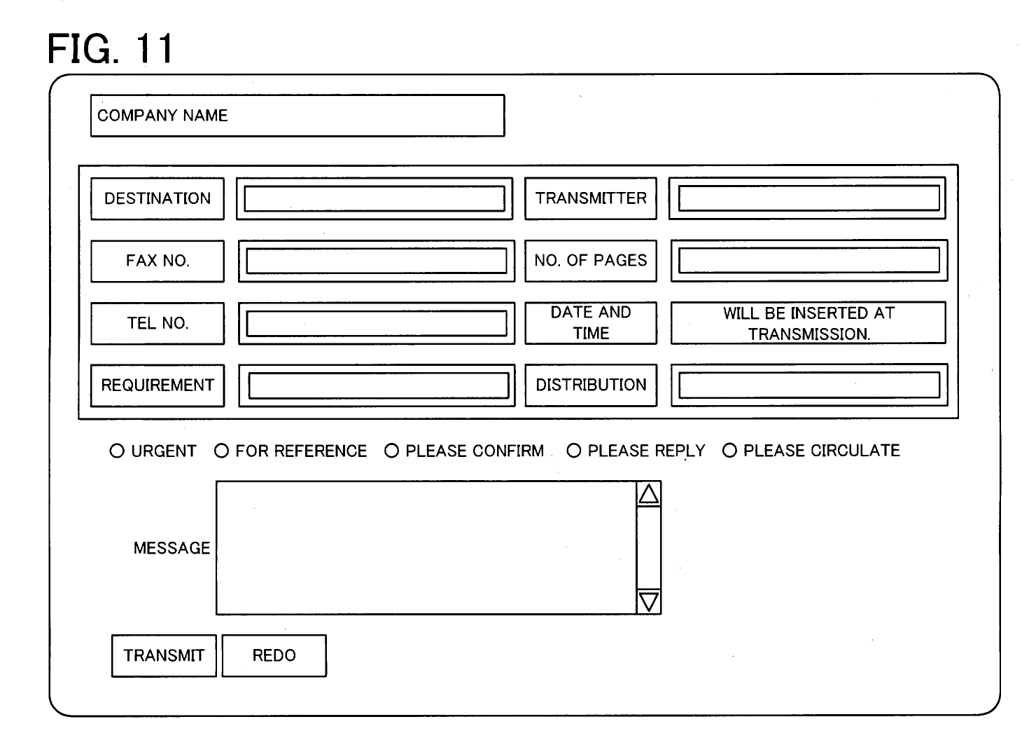

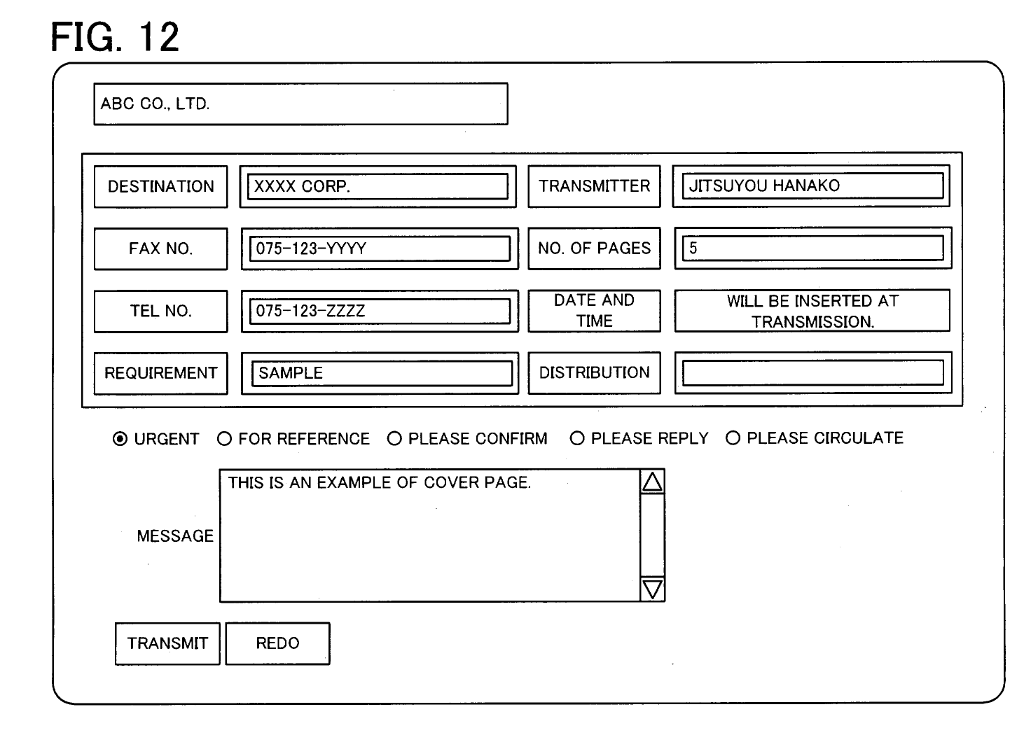

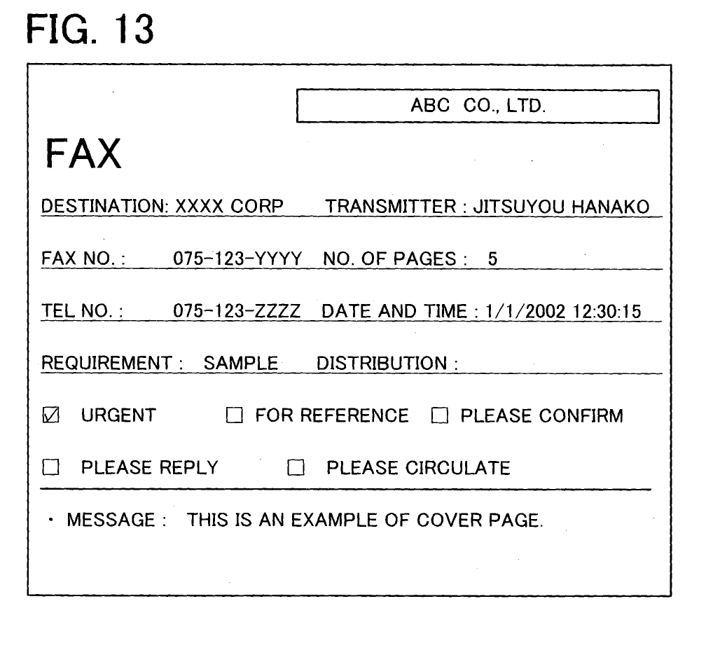

Next, an example of the above-described operation will be described by using another specific example. FIG. 8 illustrates another example of a document to be stored in the document storage unit. FIG. 9 and FIG. 10 illustrate another example of converted document data. FIG. 11 illustrates another example of a display screen at a client. FIG. 12 illustrates another example of a display screen after the information is input at a client. FIG. 13 illustrates another example of a document embed with input information. In this example, the cover page of the facsimile transmission is stored in the document storage unit 12 as the generalized original document, and used. In addition, a section for inputting the facsimile number of the destination is provided, and the facsimile transmission can be carried out directly.

In this example, the original document as shown in FIG. 8 is stored in the document storage unit 12. In this example, a part bracketed by ‘[‘ and ’]’, and a part bracketed by “{” and “}” (part that allows an input of plural lines) are the input items. ‘□’ is described as an input item (check box) for making a selection. The example shown in FIG. 8 is different from the example shown in FIG. 3, but these rules can be determined in advance.

When carrying out a facsimile transmission from the client 2 by using the document shown in FIG. 8, the original document is specified by the file name or the like, and it is requested to retrieve the original document. Then, the document server 1 retrieves the original document shown in FIG. 8 from the document storage unit 12, and generates the converted document data of the prescribed data format by the converted document data generation unit 13. For example, the converted document data generation unit 13 can generate the converted document data of the HTML format as shown in FIG. 9 and FIG. 10. Further, the description shown in FIG. 10 is a continuation of FIG. 9. For the date and time section, by being aware of the character string “CurrentTime”, a character string “WILL BE INSERTED AT TRANSMISSION” is generated in place of an input section for the date and time. Moreover, a description for generating the “transmit” button and the “redo” button are added. Further, the converted document data is not necessary to faithfully reflect the layout of the original document as shown in FIG. 9 and FIG. 10. The layout can be a simple layout to a degree in which the client 2 can recognize the part which can be input with the information. Moreover, the parts other than the input item can be abbreviated.

The converted document data as shown in FIG. 9 and FIG. 10 is transmitted to the client 2. By displaying the converted document data by the browser 21 or the like at the client 2, a screen as shown in FIG. 11 is displayed. In such a display screen, each of the input items can be input as shown in FIG. 12 as an example, and the “transmit” button can be operated. Accordingly, the converted document data including the input information is forwarded to the document server 1 in the form of electronic mail.

When the document server 1 receives the converted document data input with the information by the client 2, the document embedding unit 14 analyzes the content of the received converted document data, and extracts the input information. In addition, the document embedding unit 14 inserts the extracted input information into the original document (document shown in FIG. 8), and the document as shown in FIG. 13 is formed newly.

In this example, a facsimile number of the destination can be input as one of the input items. When the telephone number of the destination is input in the facsimile number column, the telephone number is extracted as the destination information. When the preview is indicated, after previewing and receiving an indication of the transmission from the client, a transmission processing is carried out to the newly generated document by using the destination information extracted in advance. Here, for carrying out a facsimile transmission, the new document embedded with the input information is converted into transmission data for a facsimile transmission, and sent to the facsimile communication unit 16 along with the destination information. The facsimile communication unit 16 makes an automatic call to the destination in accordance with the destination information, and transmits the transmission data by facsimile.

As described above, by using only the application program of the browser 21 or the like, the client 2 can use an existing document formed by various application programs as the original document, edit the document which should be transmitted by the facsimile, and transmit the document to the destination by facsimile. Further, in this example, an example of when carrying out the facsimile transmission was shown. However, if the electronic mail address is designated as the destination in the same manner, the new document embedded with the input information can be transmitted as electronic mail.

Further, in the example of the display shown in FIG. 11, since an indication for the preview cannot be carried out, the preview is not carried out. However, in the same manner as in the first example, it can be constructed such that an indication for the preview can be carried out. Alternatively, it can be processed as if the preview is indicated even when the indication is not carried out. When previewing, the destination information that is already designated can be reconfirmed. At this time, it can be constructed such that the destination information can be corrected.

Both in the above-described two examples, when returning the converted document data including at least the input information from the client 2 to the document server 1, an electronic mail (SMTP/POP) was used. The electronic mail (SMTP/POP) can be also used for other communications between the document server 1 and the client 2. However, the present invention is not limited to these examples. For example, other various protocols such as FTP or HTTP can be used as the communication protocol between the document server 1 and the client 2. In this case, the protocol to be used can be set for each communication. For example, HTTP can be set for when the client 2 retrieves the, document (converted document data), and electronic mail can be set for when transmitting the input converted document data. Moreover, it can be constructed to switch the protocol to be used according to the ability or the like of the client 2.

Moreover, in each of the above-described examples, an example of HTML was shown for the data format of the converted document data. However, the present invention is not limited to this example, and the data format of the converted document data can be any data format if the data format can be used by the client 2, for example, PDF, Extensible Hyper Text Markup Language (XHTML), Extensible Markup Language (XML) or the like.

In the above-described embodiment, it is possible to use a general personal computer or the like for the document server 1. In this case, the converted document data generation unit 13 or the preview image data generation unit 15 can be included as an output driver program of the application program for when forming the document. In addition, the document embedding unit 14 can be included as an input driver program.

What is claimed is:

1. A document server comprising:
a generation means for generating converted document data of a prescribed data format from a document including an input item described under a prescribed rule;
a communication means for transmitting the converted document data to a client, and receiving converted document data including an input information for the input item; and
an embedding means for embedding the input information into the input item of the document in accordance with the received converted document data.

2. The document server according to claim 1, further comprising:
a transmission means for transmitting a document which is embedded with the input information by the embedding means;
wherein destination information is included in the converted document data including input information for the input item received by the communication means, and the transmission means transmits in accordance with the destination information.

3. The document server according to claim 2, wherein the embedding means converts the document to be transmitted into transmission data of an electronic mail format, and the transmission means transmits the document in form of the electronic mail.

4. The document server according to claim 2, wherein the embedding means converts the document to be transmitted into facsimile transmission data, and the transmission means transmits the document in form of a facsimile.

5. The document server according to claim 1, further comprising:
a preview image data generation means for generating a preview image data of a prescribed data format from a document which is embedded with the input information by the embedding means;
wherein the communication means transmits the preview image data generated by the preview image data generation means to a client to realize a preview.

6. The document server according to claim 1, wherein the prescribed data format is a Hyper Text Markup Language (HTML).

7. The document server according to claim 1, wherein the prescribed data format is an Extensible Markup Language (XML).

8. The document server according to claim 1, wherein the communication means carries out a transmission and a reception by electronic mail.

9. A recording medium recording a document processing program executable by a computer, the document processing program comprising:
a generation function for generating converted document data of a prescribed data format from a document including an input item described under a prescribed rule;
a communication function for transmitting the converted document data to a client, and receiving a converted document data including an input information for the input item; and
an embedding function for embedding the input information into the input item of the document in accordance with the received converted document data.

10. The recording medium recording the document processing program according to claim 9, the document processing program further comprising:
a transmission function for transmitting a document which is embedded with the input information by the embedding function;
wherein the transmission function transmits in accordance with destination information included in converted document data which includes input information for the input item received by the communication function.

11. The recording medium recording the document processing program according to claim 10, wherein the embedding function converts a document to be transmitted into transmission data of an electronic mail format, and the transmission function transmits the electronic mail.

12. The recording medium recording the document processing program according to claim 10, wherein the embedding function converts a document to be transmitted into facsimile transmission data, and the transmission function transmits the facsimile.

13. The recording medium recording the document processing program according to claim 9, the document processing program further comprising:
a preview image data generation function for generating preview image data of a prescribed data format from a document which is embedded with the input information by the embedding function;
wherein the communication function transmits the preview image data generated by the preview image data generation function to a client to realize a preview.

14. The recording medium recording the document processing program according to claim 9, wherein the prescribed data format is a Hyper Text Markup Language (HTML).

15. The recording medium recording the document processing program according to claim 9, wherein the prescribed data format is a Extensible Markup Language (XML).

16. The recording medium recording the document processing program according to claim 9, wherein the transmission function carries out a transmission and a reception by electronic mail.

17. A document processing method comprising the steps of:
generating converted document data of a prescribed data format from a document including an input item described under a prescribed rule;
transmitting the converted document data to a client, and receiving a converted document data including input information for the input item; and
embedding the input information into the input item of the document in accordance with the received converted document data.

18. The document processing method according to claim 17, further comprising the step of:
transmitting a document which is embedded with the input information;
wherein destination information is included in the converted document data including input information for the received input item, and the transmission is carried out in accordance with the destination information.

19. The document processing method according to claim 17, further comprising the step of:
generating preview image data of a prescribed data format from a document which is embedded with the input information;
wherein the generated preview image data is transmitted to a client to realize preview.
